(19) United States
(12) Patent Application Publication
(10) Pub. No.: US 2018/0076434 A1
(43) Pub. Date: Mar. 15, 2018

(54) NONAQUEOUS ELECTROLYTE SECONDARY BATTERY LAMINATED SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventors: Chikara MURAKAMI, Osaka (JP); Chikae YOSHIMARU, Osaka (JP)

(21) Appl. No.: 15/682,948

(22) Filed: Aug. 22, 2017

(30) Foreign Application Priority Data
Sep. 15, 2016 (JP) 2016-180768

(51) Int. Cl. H01M 2/16

(52) U.S. Cl. CPC H01M 2/1686; H01M 2/166; H01M 2/1653

(57) ABSTRACT

An embodiment of the present invention provides a nonaqueous electrolyte secondary battery laminated separator having an excellent initial rate characteristic. The present nonaqueous electrolyte secondary battery laminated separator includes: a porous film containing a polyolefin-based resin; and a porous layer containing inorganic particles which have a thermal expansion coefficient of not more than 11 ppm/° C. in a temperature range of −40° C. to 200° C., the porous layer having a surface temperature increase rate of not more than 1.25° C./sec.

This Nonprovisional application claims priority under 35 U.S.C. § 119 on Patent Application No. 2016-180768 filed in Japan on Sep. 15, 2016, the entire contents of which are hereby incorporated by reference.

### TECHNICAL FIELD

The present invention relates to a laminated separator for a nonaqueous electrolyte secondary battery (hereinafter referred to as a “nonaqueous electrolyte secondary battery laminated separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries, such as lithium-ion secondary batteries, each of which has a high energy density, have been widely used as batteries for use in devices such as a personal computer, a mobile phone, and a portable information terminal. These days, efforts are being made to develop nonaqueous electrolyte secondary batteries as automotive-use batteries.

As a separator used for a nonaqueous electrolyte secondary battery such as a lithium-ion secondary battery, a microporous film containing a polyolefin as a main component has been used.

Patent Literature 1 discloses that a porous film of a lithium ion secondary battery electrode is configured to contain a specific copolymer as a binding agent and also contain specific non-conductive particles. This is intended to provide a lithium ion secondary battery electrode having a porous film which can contribute to flexibility, a rate characteristic and a cycle characteristic.

Patent Literature 2 discloses that (i) a cathode active material is configured to contain a lithium-manganese complex oxide, (ii) an anode active material is configured to contain a lithium-titanium complex oxide, and (iii) a separator is configured to contain inorganic particles. These are intended to provide a nonaqueous electrolyte secondary battery excellent in high output characteristic in a low-temperature environment.

### CITATION LIST

### [Patent Literatures]

[Patent Literature 1]

Japanese Patent No. 5569515 (Publication Date: Aug. 13, 2014)

[Patent Literature 2]

Japanese Patent Application Publication, Tokukai, No. 2009-146822 (Publication date: Jul. 2, 2009)

### SUMMARY OF INVENTION

### Technical Problem

However, in light of improvement in initial rate characteristic, the above-described conventional techniques still have room for improvement.

An embodiment of the present invention has been made in view of the above problem, and an object of an embodiment of the present invention is to provide a nonaqueous electrolyte secondary battery laminated separator, a nonaqueous electrolyte secondary battery member and a nonaqueous electrolyte secondary battery each of which has an excellent initial rate characteristic.

### Solution to Problem

A nonaqueous electrolyte secondary battery laminated separator in accordance an embodiment of the present invention includes: a porous film containing a polyolefin-based resin; and a porous layer containing inorganic particles, the inorganic particles having a thermal expansion coefficient of not more than 11 ppm/° C. in a temperature range of −40° C. to 200° C., and the porous layer having a surface temperature increase rate of not more than 1.25° C./sec in a period from a start of microwave irradiation to 15 seconds after the start of microwave irradiation, in a case where the nonaqueous electrolyte secondary battery laminated separator is impregnated with a solution containing propylene carbonate, a polyoxyalkylene-type non-ionic surfactant and water in a weight ratio of 85:12:3 and is subsequently irradiated, at an output of 1,800 W, with a microwave having a frequency of 2,455 MHz, the weight ratio being a ratio of the propylene carbonate the polyoxyalkylene-type non-ionic surfactant: water.

A nonaqueous electrolyte secondary battery laminated separator in accordance an embodiment of the present invention is preferably arranged such that the inorganic particles contain an oxygen element.

A nonaqueous electrolyte secondary battery laminated separator in accordance an embodiment of the present invention is preferably arranged such that an oxygen atomic composition percentage of the inorganic particles containing the oxygen element is not less than 60 at %.

A nonaqueous electrolyte secondary battery member in accordance an embodiment of the present invention includes: a cathode; the nonaqueous electrolyte secondary battery laminated separator; and an anode, the cathode, the nonaqueous electrolyte secondary battery laminated separator, and the anode being provided in this order.

A nonaqueous electrolyte secondary battery in accordance an embodiment of the present invention includes the nonaqueous electrolyte secondary battery laminated separator.

### Advantageous Effects of Invention

An embodiment of the present invention yields an effect of providing a nonaqueous electrolyte secondary battery laminated separator, a nonaqueous electrolyte secondary battery member and a nonaqueous electrolyte secondary battery each of which has an excellent initial rate characteristic.

### BRIEF DESCRIPTION OF DRAWINGS

FIG. 1 is a graph showing an example of a change in temperature of a surface of a porous layer.

### DESCRIPTION OF EMBODIMENTS

An embodiment of the present invention is described below. Note, however, that the present invention is not limited to such an embodiment. Note also that a numerical range “A to B” herein means “not less than A and not more than B” unless otherwise specified.

[1. Nonaqueous Electrolyte Secondary Battery Laminated Separator]

A nonaqueous electrolyte secondary battery laminated separator in accordance with an embodiment of the present invention is to be provided between a cathode and an anode of a nonaqueous electrolyte secondary battery, and includes a porous film and a porous layer.

<1-1. Porous Film>

The porous film only needs to be a base material that is porous and filmy, and contains a polyolefin-based resin (a polyolefin-based porous base material). The porous film is a film that (i) has therein pores connected to one another and (ii) allows a gas or a liquid to pass therethrough from one surface to the other.

The porous film is arranged such that in a case where the battery generates heat, the porous film is melted so as to make the nonaqueous electrolyte secondary battery laminated separator non-porous. This allows the porous film to impart a shutdown function to the nonaqueous electrolyte secondary battery laminated separator. The porous film can be made of a single layer or a plurality of layers.

The porous film can have any thickness that is appropriately set in view of a thickness of a nonaqueous electrolyte secondary battery member of the nonaqueous electrolyte secondary battery. The porous film has a thickness preferably of 4 μm to 40 μm, more preferably of 5 μm to 30 μm, and still more preferably of 6 μm to 205 μm.

The porous film has a volume-based porosity of preferably 20% by volume to 80% by volume, more preferably 25% by volume to 70% by volume, and still more preferably 30% by volume to 60% by volume. The porosity in the above range allows the non-aqueous secondary battery separator to (i) retain a larger amount of electrolyte, (ii) ensure a sufficient strength of the separator, and (iii) achieve a function of reliably preventing (shutting down) a flow of an excessively large current at a lower temperature.

The porous film has pores having an average diameter (an average pore diameter) of preferably 0.010 μm to 0.30 μm, more preferably 0.015 μm to 0.20 μm, and still more preferably 0.020 μm to 0.15 μm. The porous film having an average diameter in the above range, in a case where the porous film is used as a separator, can achieve sufficient ion permeability and prevent particles from entering the cathode or the anode.

It is preferable that the porous film contain a polyolefin component at a proportion of not less than 50% by volume with respect to whole components contained in the porous film. Such a proportion of the polyolefin component is more preferably not less than 90% by volume, and still more preferably not less than 95% by volume. The porous film preferably contains, as the polyolefin component, a high molecular weight component having a weight-average molecular weight of 5×10⁵ to 15×10⁶. The porous film particularly preferably contains, as the polyolefin component, a polyolefin component having a weight-average molecular weight of not less than 1,000,000. This is because the porous film which contains such a polyolefin component allows the porous film and the entire nonaqueous electrolyte secondary battery laminated separator to have a greater strength.

Examples of the polyolefin-based resin constituting the porous film include high molecular weight homopolymers or copolymers produced through polymerization of ethylene, propylene, 1-butene, 4-methyl-1-pentene, 1-hexene, and/or the like. The porous film can include a layer containing only one of these polyolefin-based resins and/or a layer containing two or more of these polyolefin-based resins. Among these, a high molecular weight polyethylene containing ethylene as a main component is particularly preferable as the polyolefin-based resin constituting the porous film. Note that the porous film can contain a non-polyolefin component, as long as the non-polyolefin component does not impair the function of the layer.

Examples of such a polyethylene-based resin include low-density polyethylene, high-density polyethylene, linear polyethylene (an ethylene-a-olefin copolymer), ultra-high molecular weight polyethylene having a weight-average molecular weight of not less than 1,000,000, and the like. Of these polyethylene-based resins, ultra-high molecular weight polyethylene having a weight-average molecular weight of not less than 1,000,000 is particularly preferable.

The porous film has normally an air permeability in a range from 30 sec/100 cc to 700 sec/100 cc, and preferably in a range from 40 sec/100 cc to 400 sec/100 cc, in terms of Gurley values. A porous film having such an air permeability achieves sufficient ion permeability in a case where the porous film is used as a separator.

The porous film has a mass per unit area of preferably 4 g/m² to 20 g/m², more preferably 4 g/m² to 12 g/m², and still more preferably 5 g/m² to 12 g/m², because such a mass per unit area of the porous film can increase (i) a strength, a thickness, handling easiness, and a weight of the porous film and (ii) a weight energy density and a volume energy density of a nonaqueous electrolyte secondary battery including the porous film as a nonaqueous electrolyte secondary battery separator.

The following description discusses a method for producing the porous film. In view of production cost, the porous film which contains a polyolefin-based resin as a main component is preferably produced by a method including, for example, the following steps of:

(1) obtaining a polyolefin resin composition by kneading (i) a polyolefin-based resin and (ii) a pore forming agent such as calcium carbonate or a plasticizing agent;

(2) forming (rolling) a sheet by using a reduction roller to roll the polyolefin resin composition obtained in the step (1);

(3) removing the pore forming agent from the sheet obtained in the step (2); and

(4) obtaining a porous film by stretching the sheet obtained in the step (3).

<1-2. Porous Layer>

The porous layer is laminated to one side or both sides of the porous film. The porous layer that is laminated to one side of the porous film is preferably laminated to a surface of the porous film which surface faces a cathode of a nonaqueous electrolyte secondary battery which includes the laminated separator as a nonaqueous electrolyte secondary battery member, and is more preferably laminated to a surface of the porous film which surface is in contact with the cathode.

The inventors of the present invention have first found that an initial rate characteristic can be improved by (i) setting a temperature increase rate of a surface of the porous layer in a specific range and (ii) setting a thermal expansion coefficient of inorganic particles in a specific range, which inorganic particles are contained, as a filler, in the porous layer.

A discharge rate characteristic including the initial rate characteristic is considered to be influenced by denseness of the porous layer. As the porous layer becomes less dense (rougher), the discharge rate characteristic improves more since lithium ions more easily pass through the porous layer. On the other hand, as the porous layer becomes denser (more compact), it tends to be less easy for lithium ions to pass through the porous layer.

A factor that influences the denseness of the porous layer as described above is, for example, a void structure (e.g., an area of an inner wall of each void and a degree of winding of each void) of the porous layer. As each of the area of an inner wall of each void and the degree of winding of each void becomes lower, the porous layer is considered to become less dense. Conversely, as each of the area of an inner wall of each void and the degree of winding of each void becomes larger, the porous layer is considered to become denser.

The inventors of the present invention focused on a temperature increase rate of a surface of the porous layer, as a parameter which reflects denseness of the porous layer. As the porous layer becomes less dense, the temperature increase rate of the surface of the porous layer becomes lower. Conversely, as the porous layer becomes denser, the temperature increase rate of the surface of the porous layer becomes higher.

In the nonaqueous electrolyte secondary battery laminated separator in accordance with an embodiment of the present invention, the surface of the porous layer has a temperature increase rate of not more than 1.25° C./sec, preferably not more than 1.23° C./sec, and more preferably not more than 1.20° C./sec in a period from a start of microwave irradiation to 15 seconds after the start of microwave irradiation, in a case where the nonaqueous electrolyte secondary battery laminated separator is impregnated with a solution containing propylene carbonate, a polyoxyalkylene-type non-ionic surfactant and water in a weight ratio (propylene carbonate: polyoxyalkylene-type non-ionic surfactant: water) of 85:12:3 and is subsequently irradiated, at an output of 1,800 W, with a microwave having a frequency of 2,455 MHz.

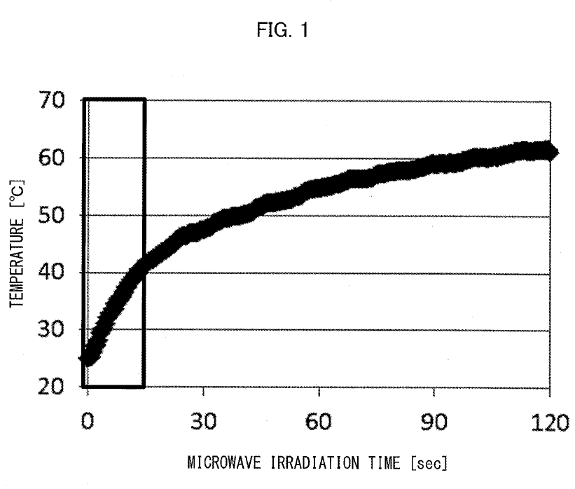

FIG. 1 is a graph showing an example of a change in temperature of the surface of the porous layer. The temperature increase rate in a period from a start of irradiation to 15 seconds after the start of irradiation corresponds to a slope at a maximum contribution rate (R²) obtained in a case where a curve of an area enclosed by solid line in FIG. 1 is subjected to straight-line approximation.

In a case where the temperature increase rate of the surface of the porous layer is not more than 1.25° C./sec, the porous layer is not too dense. In other words, in such a case, a flow path of the lithium ions is neither too long nor too thin. Further, the flow path does not have too many branches. Accordingly, in the above case, the lithium ions easily pass through the porous layer and therefore the discharge rate characteristic can be improved.

Further, the temperature increase rate is preferably not less than 0.93° C./sec, and more preferably not less than 0.95° C./sec. The porous layer having the temperature increase rate of not less than 0.93° C./sec is preferable, because such a porous layer has a certain level of denseness and makes it possible to produce a stronger and safer separator.

The polyoxyalkylene-type non-ionic surfactant herein means a polymer having an oxyalkylene group which polymer acts as a non-ionic surfactant. The polyoxyalkylene-type non-ionic surfactant, which is not particularly limited to any specific surfactant, can be any surfactant capable of accelerating permeation of the above solution in the separator. The polyoxyalkylene-type non-ionic surfactant generates heat very slightly as compared water. On this account, a difference in structure between polyoxyalkylene-type non-ionic surfactants is considered to have no significant effect on an amount of heat generated. Specifically, the polyoxyalkylene-type non-ionic surfactant can be, for example, any of polyoxyalkylene alkyl ethers, polyoxyalkylene tridecyl ethers, polyoxyalkylene polycyclic phenyl ethers, polyoxyalkylene aryl ethers, compounds represented by the following Formula (1), and the like.

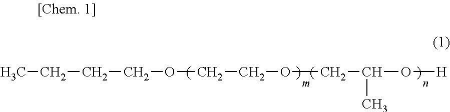

where m=5 to 10 and n=10 to 25, and the sequence of each repeating unit can be any of a block sequence, a random sequence, and an alternate sequence.

The compounds represented by the above Formula (1) can be also called ethylene oxide/propylene oxide copolymers. Specific examples of the polyoxyalkylene-type non-ionic surfactant made of such a compound include commercially available SN-WET 980 (manufactured by San Nopco Limited). Note that SN-WET 980 is made of a compound represented by the above Formula (1) wherein an average value of m is 7 and an average value of n is 19.

Further, the porous layer contains inorganic particles having a thermal expansion coefficient of not more than 11 ppm/° C. in a temperature range from −40° C. to 200° C. The inorganic particles herein means particles made of an inorganic matter. The thermal expansion coefficient of the inorganic particles may affect (i) uniformity of constituent distribution and void distribution (dispersion uniformity) in the porous layer, which uniformity is obtained as a result of easiness in uniformizing constituents and voids at the time of formation of the porous layer, and (ii) uniformity of void deformation degrees (void deformation uniformity) during battery operation. As the voids and the constituents are distributed more uniformly in the porous layer (in a case where the dispersion uniformity is higher) or as the void deformation uniformity during battery operation is higher, lithium ions pass through the porous layer more easily and therefore, the discharge rate characteristic tends to improve.

In a case where the thermal expansion coefficient in a temperature range from −40° C. to 200° C. is not more than 11 ppm/° C., (i) it is possible to obtain a porous layer in which voids and constituents are uniformly distributed and (ii) the voids of this porous layer less deform during battery operation. This allows lithium ions to easily pass through the porous layer, so that the discharge rate characteristic can be improved.

Note that the thermal expansion coefficient is preferably more than 0 ppm/° C., and more preferably not less than 1 ppm/° C. In a case where the porous layer is deformed due to heat generated during operation of the nonaqueous electrolyte secondary battery, stress may concentrate on a position where the inorganic particles and a binder resin which constitute the porous layer are in contact with each other. As a result, the void structure inside the porous layer may be irreversibly-changed. This may consequently produce a harmful influence on a battery characteristic. In view of avoidance of such a harmful influence, the thermal expansion coefficient in the above range is preferable.

A lower limit of a content of the inorganic particles in the porous layer is preferably not less than 50% by weight, more preferably not less than 70% by weight, and still more preferably not less than 90% by weight, with respect to a total weight of the inorganic particles and a resin constituting the porous layer. Meanwhile, an upper limit of the content of the inorganic particles in the porous layer is preferably not more than 99% by weight, and more preferably not more than 98% by weight. In view of heat resistance, the content of the inorganic particles is preferably not less than 50% by weight. Meanwhile, in light of adhesion between inorganic particles, the content of the inorganic particles is preferably not more than 99% by weight. In addition, the porous layer containing the inorganic particles can improve slidability and heat resistance of a separator including the porous layer.

The inorganic particles are not specifically limited provided that the inorganic particles are a filler which is stable in a nonaqueous electrolyte and is also stable electrochemically. In view of ensuring safety of the battery, the inorganic particles are preferably a filler which has a heat-resistant temperature of not less than 150° C.

The inorganic particles are preferably inorganic particles containing an oxygen element. The inorganic particles containing an oxygen element herein mean particles made of an inorganic matter containing an oxygen element. Examples of the inorganic matter containing an oxygen element include: barium titanate zirconate, calcium titanate, aluminum titanate, borosilicate glass, and the like, but the inorganic matter containing an oxygen element is not limited thereto.

The inorganic particles can have a shape that varies depending on, for example, (i) a method for producing the inorganic particles and/or (ii) a condition under which the inorganic particles are dispersed during preparation of a coating solution for forming the porous layer. The inorganic particles can have any of various shapes such as a spherical shape, an oblong shape, a rectangular shape, a gourd shape formed as a result of thermal fusion bonding of spherical particles, and an indefinite irregular shape. In view of ion permeability and liquid retention properties of the porous layer, the shape of the inorganic particles is more preferably a gourd shape or an indefinite irregular shape.

The resin contained in the porous layer is preferably insoluble in an electrolyte of a battery and also preferably electrochemically stable in a range of use of the battery. Specific examples of the resin include: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; fluorine-containing rubbers each having a glass transition temperature of not more than 23° C., among the above fluorine-containing resins; aromatic polyamides; wholly aromatic polyamides (aramid resins); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not less than 180° C., such as polyphenylene ether, polysulfone, polyether sulfone, polyphenylene sulfide, polyetherimide, polyamide-imide, polyether amide, and polyester; water-soluble polymers such as polyvinyl alcohol, polyethylene glycol, cellulose ether, sodium alginate, polyacrylic acid, polyacrylamide, and polymethacrylic acid; and the like.

Suitable examples of the resin contained in the porous layer include a water-insoluble polymer. In other words, the porous layer is preferably produced with the use of an emulsion or a dispersion obtained by dispersing a water-insoluble polymer (e.g. acrylate resin) in an aqueous solvent, so that the porous layer contains the water-insoluble polymer as the resin.

Note that the water-insoluble polymer herein means a polymer that does not become dissolved in an aqueous solvent but becomes particles so as to be dispersed in the aqueous solvent. A “water-insoluble polymer” is defined as a polymer which has an insoluble content equal to or greater than 90% by weight in a case where 0.5 g of the polymer is dissolved in 100 g of water at 25° C. Meanwhile, a “water-soluble polymer” is defined as a polymer which has an insoluble content of less than 0.5% by weight in a case where 0.5 g of the polymer is dissolved in 100 g of water at 25° C. The shape of each of the particles of the water-insoluble polymer is not limited to any particular one, but is preferably a spherical shape.

The water-insoluble polymer, which is polymer particles, is produced by, for example, polymerizing, in an aqueous solvent, a monomer composition containing a monomer (described later).

Examples of the monomer constituting the water-insoluble polymer include styrene, vinyl ketone, acrylonitrile, methyl methacrylate, ethyl methacrylate, glycidyl methacrylate, glycidyl acrylate, methyl acrylate, ethyl acrylate, butyl acrylate, and the like.

The polymer can contain, in addition to a homopolymer of monomers, a copolymer of two or more kinds of monomers. Examples of the polymer includes fluorine-containing resins such as polyvinylidene fluoride, a vinylidene fluoride copolymer (such as a vinylidene fluoride-hexafluoropropylene copolymer and a vinylidene fluoride-hexafluoropropylene-tetrafluoroethylene copolymer), and a tetrafluoroethylene copolymer (such as an ethylene-tetrafluoroethylene copolymer); melamine resin; urea resin; polyethylene; polypropylene; polymethyl acrylate, polymethyl methacrylate, and polybutyl acrylate; and the like.

The aqueous solvent contains water and is not limited to any particular one, provided that the water-insoluble polymer particles can be dispersed in the aqueous solvent. The aqueous solvent can contain any amount of organic solvent, examples of which include methanol, ethanol, isopropyl alcohol, acetone, tetrahydrofuran, acetonitrile, and N-methylpyrrolidone, any of which can be mixed with water at any ratio. The aqueous solvent can also contain an additive(s) such as a dispersing agent and/or a surfactant. Examples of the surfactant include sodium dodecylbenzene sulfonate, and the like. Examples of the dispersing agent include: a polyacrylic acid, a sodium salt of carboxymethyl cellulose, and the like. In a case where the above additives such as the organic solvent and/or the surfactant are used, the additives can be used individually, or a mixture of two or more of the additives can be used. Note that in a case where the organic solvent is used, a ratio by weight of the organic solvent is 0.1% by weight to 99% by weight, preferably 0.5% by weight to 80% by weight, and more preferably 1% by weight to 50% by weight when a sum of a weight of the organic solvent and a weight of water is 100% by weight.

Note that the resin to be contained in the porous layer can be a resin of a single kind or a mixture of two or more kinds of resins.

Specific examples of the aromatic polyamides include poly(paraphenylene terephthalamide), poly(methaphenylene isophthalamide), poly(parabenzamide), poly(methabenzamide), poly(4,4′-benzanilide terephthalamide), poly(paraphenylene-4,4′-biphenylene dicarboxylic amide), poly(methaphenylene-4,4′-biphenylene dicarboxylic amide), poly(paraphenylene-2,6-naphthalene dicarboxylic amide), poly(methaphenylene-2,6-naphthalene dicarboxylic amide), poly(2-chloroparaphenylene terephthalamide), a paraphenylene terephthalamide/2,6-dichloroparaphenylene terephthalamide copolymer, and a methaphenylene terephthalamide/2,6-dichloroparaphenylene terephthalamide copolymer. Out of these aromatic polyamides, poly(paraphenylene terephthalamide) is more preferable.

The resin is more preferably a polyolefin, a fluorine-containing resin, a fluorine-containing rubber, an aromatic polyamide, a water-soluble polymer, or a water-insoluble polymer in the form of particles dispersed in an aqueous solvent, among the above resins. In a case where the porous layer is provided so as to face a cathode of a nonaqueous electrolyte secondary battery, a fluorine-containing resin is particularly preferable. This is because use of a fluorine-containing resin makes it easier to maintain various performance capabilities such as a rate characteristic and a resistance characteristic (solution resistance) of the nonaqueous electrolyte secondary battery even in a case where deterioration in acidity occurs during battery operation. Among the fluorine-containing resins, a polyvinylidene fluoride-based resin (e.g., (i) a copolymer of vinylidene fluoride and at least one monomer selected from the group consisting of hexafluoropropylene, tetrafluoroethylene, trifluoroethylene, trichloroethylene, and vinyl fluoride and (ii) a homopolymer of vinylidene fluoride (that is, polyvinylidene fluoride), or the like) is particularly preferable. This is because a water-soluble polymer and a water-insoluble polymer in the form of particles dispersed in an aqueous solvent can each allow water to be used as a solvent to form a porous layer, and are therefore more preferable in view of a process and an environmental impact. Cellulose ether and sodium alginate are still more preferable as the water-soluble polymer and cellulose ether is particularly preferable.

Specific examples of the cellulose ether include carboxymethyl cellulose (CMC), hydroxyethyl cellulose (HEC), carboxy ethyl cellulose, methyl cellulose, ethyl cellulose, cyan ethyl cellulose, and oxyethyl cellulose. Among these, CMC and HEC, which deteriorate less after being used for a long time and have excellent chemical stability, are more preferable, and CMC is particularly preferable.

In view of adhesion between inorganic particles, preferable examples of the water-insoluble polymer in the form of particles dispersed in the aqueous solvent include (i) a homopolymer of acrylate monomers such as methyl methacrylate, ethyl methacrylate, glycidyl methacrylate, glycidyl acrylate, methyl acrylate, ethyl acrylate, and butyl acrylate and (ii) a copolymer of two or more kinds of monomers.

A lower limit of a content of the resin in the porous layer is preferably not less than 1% by weight, and more preferably not less than 2% by weight, with respect to a total weight of the porous layer. Meanwhile, an upper limit of a content of the resin in the porous layer is preferably in a range of not more than 50% by weight, and more preferably not more than 30% by weight. It is preferable that a content of the PVDF-based resin be not less than 1% by weight, in view of improvement of adhesion between inorganic particles, in other words, in view of prevention of falling of the inorganic particles from the porous layer. It is preferable that the content of the PVDF-based resin be not more than 50% by weight, in view of a battery characteristic (in particular, ion permeability resistance) and heat resistance.

The porous layer can contain other components different from the above-described inorganic particles and resin. Examples of these other components include a surfactant, an antioxidant, an antistatic agent, and the like. Further, a content of the other components is preferably 0% by weight to 50% by weight with respect to a total weight of the porous layer.

The porous layer is formed by dissolving or dispersing the resin in a solvent and dispersing the inorganic particles. In a method for producing a coating solution for formation of the porous layer, the solvent (dispersion medium), which is not particularly limited to any specific solvent, only needs to (i) have no harmful influence on the porous film, (ii) uniformly and stably dissolve the resin, and (iii) uniformly and stably disperse the inorganic particles. Specific examples of the solvent (dispersion medium) include: water; lower alcohols such as methyl alcohol, ethyl alcohol, n-propyl alcohol, isopropyl alcohol, and t-butyl alcohol; acetone, toluene, xylene, hexane, N-methyl-2-pyrrolidone, N,N-dimethylacetamide, and N,N-dimethylformamide; and the like. The above solvents (dispersion media) can be used in only one kind or in combination of two or more kinds.

The coating solution has a shear viscosity of preferably not more than 1 Pa·s and more preferably not more than 0.5 Pa·s. In a case where the shear viscosity is high, the constituents easily interact with each other and tend to be dense. In a case where the coating solution has a shear viscosity of not more than 1 Pa·s, the denseness of the porous layer is not too high and the constituents can be more uniformly dispersed. Note that the shear viscosity herein indicates a shear viscosity at a shear rate 0.4 [1/sec] in Interval 2 in a case where a shear viscosity is measured continuously (i) first in Interval 1 in which a shear rate is increased from 0.1 to 1000 [1/sec] and (ii) then in Interval 2 in which a shear rate is decreased from 1000 to 0.1 [1/sec].

Further, preferably, the inorganic particles containing an oxygen element have an atomic composition percentage of oxygen of not less than 60 at %. In a case where the atomic composition percentage of oxygen is not less than 60 at %, inorganic particles repel each other and are accordingly easily dispersed. Therefore, the inorganic particles are unlikely to interact with each other. This makes it possible to uniformly disperse the constituents.

In other words, it is possible to control a temperature increase rate of a surface of the porous layer by controlling the shear viscosity of the coating solution and the atomic composition percentage of oxygen contained in the inorganic particles containing an oxygen element. Further, this makes it possible to control permeation of lithium ions.

The coating solution can be formed by any method provided that the coating solution can meet conditions such as a resin solid content (resin concentration) and/or an inorganic particle amount each necessary for obtainment of a desired porous layer. Specific examples of a method for forming the coating solution include a mechanical stirring method, an ultrasonic dispersion method, a high-pressure dispersion method, a media dispersion method, and the like.

Further, the inorganic particles can be dispersed in the solvent (dispersion medium) by use of, for example, a conventionally publicly known dispersing machine such as a three-one motor, a homogenizer, a media dispersing machine, or a pressure dispersing machine. Furthermore, it is possible to prepare a coating solution concurrently with wet grinding carried out so as to obtain inorganic particles having a desired average particle diameter. The preparation of the coating solution concurrently with the wet grinding of the inorganic particles can be carried out by supplying (i) a liquid in which a resin is dissolved or swollen or (ii) a resin emulsion to a wet grinding apparatus during the wet grinding. That is, wet grinding of inorganic particles and preparation of a coating solution can be concurrently carried out in a single step.

In addition, the coating solution can contain, as a component different from the resin and the inorganic particles, an additive(s) such as a disperser, a plasticizer, a surfactant, and/or a pH adjustor, provided that the additive(s) does/do not impair the object of the present invention. Note that the additive(s) can be contained in an amount that does not impair the object of the present invention.

A method for applying the coating solution to the porous film (e.g., a method for forming the porous layer on a surface of the porous film which has been appropriately subjected to a hydrophilization treatment) is not particularly restricted. In a case where the porous layer is laminated to both sides of the porous film, (i) a sequential lamination method in which the porous layer is formed on one side of the porous film and then the porous layer is formed on the other side of the porous film, or (ii) a simultaneous lamination method in which the porous layer is formed simultaneously on both sides of the porous film is applicable to the case.

Examples of a method for forming the porous layer include: a method in which the coating solution is directly applied to the surface of the porous film and then the solvent (dispersion medium) is removed; a method in which the coating solution is applied to an appropriate support, the porous layer is formed by removing the solvent (dispersion medium), and thereafter the porous layer thus formed and the porous film are pressure-bonded and subsequently the support is peeled off; a method in which the coating solution is applied to the appropriate support and then the porous film is pressure-bonded to an application surface, and subsequently the support is peeled off and then the solvent (dispersion medium) is removed; a method in which the porous film is immersed in the coating solution so as to be subjected to dip coating, and thereafter the solvent (dispersion medium) is removed; and the like.

The porous layer can have a thickness that is controlled by adjusting, for example, a thickness of a coating film that is moist (wet) after coating, a weight ratio between the resin and the inorganic particles, and/or a solid content concentration (a sum of a resin concentration and an inorganic particle concentration) of the coating solution. Note that it is possible to use, as the support, a film made of resin, a belt made of metal, or a drum, for example.

A method for applying the coating solution to the porous film or the support is not particularly limited to any specific method provided that the method achieves a necessary mass per unit area and a necessary coating area. The coating solution can be applied to the porous film or the support by a conventionally publicly known method. Specific examples of the conventionally publicly known method include a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray application method, and the like.

Generally, the solvent (dispersion medium) is removed by drying. Examples of a drying method include natural drying, air-blowing drying, heat drying, vacuum drying, and the like. Note, however, that any drying method is usable provided that the drying method allows the solvent (dispersion medium) to be sufficiently removed. For the drying, it is possible to use an ordinary drying device.

Further, it is possible to carry out the drying after replacing, with another solvent, the solvent (dispersion medium) contained in the coating solution. Examples of a method for removing the solvent (dispersion medium) after replacing the solvent (dispersion medium) with another solvent include a method in which another solvent (hereinafter referred to as a solvent X) is used that is dissolved in the solvent (dispersion medium) contained in the coating solution and does not dissolve the resin contained in the coating solution. Specific examples of the method for removing the solvent (dispersion medium) after replacing the solvent (dispersion medium) with another solvent include a method in which the porous film or the support on which a coating film has been formed by application of the coating solution is immersed in the solvent X, the solvent (dispersion medium) contained in the coating film formed on the porous film or the support is replaced with the solvent X, and thereafter the solvent X is evaporated. This method makes it possible to efficiently remove the solvent (dispersion medium) from the coating solution.

Assume that heating is carried out so as to remove the solvent (dispersion medium) or the solvent X from the coating film of the coating solution which coating film has been formed on the porous film or the support. In this case, in order to prevent the porous film from having a lower air permeability due to contraction of pores of the porous film, it is desirable to carry out heating at a temperature at which the porous film does not have a lower air permeability. Specifically, the heating is carried out at preferably 10° C. to 120° C., and more preferably 20° C. to 80° C.

A porous film on which a porous layer is to be formed is preferably subjected to a hydrophilization treatment before a coating solution described below is applied thereto. Performing a hydrophilization treatment on the porous film further improves coating easiness of the coating solution and thus allows a more uniform porous layer to be formed. This hydrophilization treatment is effective in a case where a solvent (disperse medium) contained in the coating solution has a high proportion of water.

Specific examples of the hydrophilization treatment include publicly known treatments such as (i) a chemical treatment involving an acid, an alkali, or the like, (ii) a corona treatment, and (iii) a plasma treatment. Among these hydrophilization treatments, a corona treatment is preferable because it can not only hydrophilize the porous film within a relatively short time period, but also hydrophilize only a surface and its vicinity of the porous film to leave the inside of the porous film unchanged in quality.

In a case where the porous film is used as the base material to form the nonaqueous electrolyte secondary battery laminated separator by laminating the porous layer to one side or both sides of the porous film, the porous layer formed by the method described earlier has, per one side thereof, a film thickness preferably of 0.5 μm to 15 μm and more preferably of 2 μm to 10 μm.

In a case where a total thickness of the porous layer provided on both sides of the porous film is not less than 1 μm and the porous layer is used in the nonaqueous electrolyte secondary battery, it is possible to satisfactorily prevent an internal short circuit caused by, for example, damage to the nonaqueous electrolyte secondary battery. Furthermore, such a porous layer makes it possible to cause an electrolyte to be sufficiently retained in the porous layer.

Meanwhile, in a case where a total thickness of the porous layer provided on both sides of the porous film is not more than 30 μm and the porous layer is used in the nonaqueous electrolyte secondary battery, it is possible to prevent an increase in permeation resistance of lithium ions in the entire nonaqueous electrolyte secondary battery laminated separator. This makes it possible to sufficiently prevent (i) deterioration of the cathode of the nonaqueous electrolyte secondary battery in a case where charge and discharge cycles are repeated and (ii) deterioration in rate characteristic and cycle characteristic of the nonaqueous electrolyte secondary battery. Furthermore, such a porous layer can prevent a distance between the cathode and the anode from increasing. Accordingly, the nonaqueous electrolyte secondary battery does not increase in size.

In a case where the porous layer is laminated to both sides of the porous film, physical properties of the porous layer which are described below at least refer to physical properties of the porous layer which is laminated to a surface of the porous film which surface faces the cathode of the nonaqueous electrolyte secondary battery which includes the porous film.

The porous layer only needs to have, per one side thereof, a mass per unit area which mass is appropriately determined in view of a strength, a film thickness, a weight, and handleability of the nonaqueous electrolyte secondary battery laminated separator. The porous layer normally has a mass per unit area preferably of 1 g/m² to 20 g/m² and more preferably of 2 g/m² to 10 g/m².

The porous layer which has a mass per unit area which mass falls within the above range allows an increase in weight energy density and/or volume energy density of the nonaqueous electrolyte secondary battery which includes the porous layer.

The porous layer has a porosity preferably of 20% by volume to 90% by volume and more preferably of 30% by volume to 80% by volume so as to achieve sufficient ion permeability. The porous layer has pores having a pore diameter preferably of not more than 1 μm and more preferably of not more than 0.5 μm. The porous layer whose pores are set to have a pore diameter falling within the above range allows the nonaqueous electrolyte secondary battery which includes the nonaqueous electrolyte secondary battery laminated separator which includes the porous layer to achieve sufficient ion permeability.

The nonaqueous electrolyte secondary battery laminated separator has a Gurley air permeability preferably of 30 sec/100 mL to 1000 sec/100 mL and more preferably of 50 sec/100 mL to 800 sec/100 mL. The nonaqueous electrolyte secondary battery laminated separator which has a Gurley air permeability falling within the above range makes it possible to obtain sufficient ion permeability in a case where the nonaqueous electrolyte secondary battery laminated separator is used as a member for the nonaqueous electrolyte secondary battery.

Meanwhile, the nonaqueous electrolyte secondary battery laminated separator which has a lower Gurley air permeability means that the separator has a coarser laminated structure due to a higher porosity thereof. In a case where the nonaqueous electrolyte secondary battery laminated separator has a Gurley air permeability of not less than 30 sec/100 mL, the porosity thereof is not too high. This causes the separator to have a sufficient strength, so that the separator may be sufficient in shape stability particularly at a high temperature. Moreover, the nonaqueous electrolyte secondary battery laminated separator which has a Gurley air permeability of not more than 1000 sec/100 mL makes it possible to obtain sufficient ion permeability in a case where the separator is used as a nonaqueous electrolyte secondary battery member. This can cause the nonaqueous electrolyte secondary battery to have an improved battery characteristic.

[2. Nonaqueous Electrolyte Secondary Battery Member, Nonaqueous Electrolyte Secondary Battery]

A nonaqueous electrolyte secondary battery member in accordance with an embodiment of the present invention is a nonaqueous electrolyte secondary battery member including a cathode, the nonaqueous electrolyte secondary battery laminated separator, and an anode that are provided in this order. A nonaqueous electrolyte secondary battery in accordance with an embodiment of the present invention includes the nonaqueous electrolyte secondary battery laminated separator. The following description is given by (i) taking a lithium ion secondary battery member as an example of the nonaqueous electrolyte secondary battery member and (ii) taking a lithium ion secondary battery as an example of the nonaqueous electrolyte secondary battery. Note that components of the nonaqueous electrolyte secondary battery member and the nonaqueous electrolyte secondary battery except the nonaqueous electrolyte secondary battery laminated separator are not limited to those discussed in the following description.

In the nonaqueous electrolyte secondary battery, it is possible to use, for example, a nonaqueous electrolyte obtained by dissolving lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄, and the like. The above lithium salts can be used in only one kind or in combination of two or more kinds. Of the above lithium salts, at least one kind of fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Specific examples of the organic solvent of the nonaqueous electrolyte include: carbonates such as ethylene carbonate, propylene carbonate, dimethyl carbonate, diethyl carbonate, ethyl methyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropylmethyl ether, 2,2,3,3-tetrafluoropropyldifluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethylsulfoxide, and 1,3-propanesultone; a fluorine-containing organic solvent obtained by introducing a fluorine group in the organic solvent; and the like. The above organic solvents can be used in only one kind or in combination of two or more kinds. Of the above organic solvents, a carbonate is preferable, and a mixed solvent of cyclic carbonate and acyclic carbonate or a mixed solvent of cyclic carbonate and an ether is more preferable. The mixed solvent of cyclic carbonate and acyclic carbonate is more preferably exemplified by a mixed solvent containing ethylene carbonate, dimethyl carbonate, and ethyl methyl carbonate. This is because the mixed solvent containing ethylene carbonate, dimethyl carbonate, and ethyl methyl carbonate operates in a wide temperature range, and is refractory also in a case where a graphite material such as natural graphite or artificial graphite is used as an anode active material.

Normally, a sheet cathode in which a cathode current collector supports thereon a cathode mix containing a cathode active material, an electrically conductive material, and a binding agent is used as the cathode.

Examples of the cathode active material include a material that is capable of doping and dedoping lithium ions. Specific examples of such a material include lithium complex oxides each containing at least one kind of transition metal selected from the group consisting of V, Mn, Fe, Co, and Ni. Of the above lithium complex oxides, a lithium complex oxide having an β-NaFeO₂ structure, such as lithium nickel oxide or lithium cobalt oxide, or a lithium complex oxide having a spinel structure, such as lithium manganese spinel is more preferable. This is because such a lithium complex oxide is high in average discharge potential. The lithium complex oxide can contain various metallic elements, and lithium nickel complex oxide is more preferable. Further, it is particularly preferable to use lithium nickel complex oxide which contains at least one kind of metallic element so that the at least one kind of metallic element accounts for 0.1 mol % to 20 mol % of a sum of the number of moles of the at least one kind of metallic element and the number of moles of Ni in lithium nickel oxide, the at least one kind of metallic element being selected from the group consisting of Ti, Zr, Ce, Y, V, Cr, Mn, Fe, Co, Cu, Ag, Mg, Al, Ga, In, and Sn. This is because such a lithium nickel complex oxide is excellent in cycle characteristic during use of the nonaqueous electrolyte secondary battery at a high capacity. Especially an active material which contains Al or Mn and has an Ni content of not less than 85% and more preferably of not less than 90% is particularly preferable. This is because such an active material is excellent in cycle characteristic during use of the nonaqueous electrolyte secondary battery at a high capacity, the nonaqueous electrolyte secondary battery including the cathode containing the active material.

Examples of the electrically conductive material include carbonaceous materials such as natural graphite, artificial graphite, cokes, carbon black, pyrolytic carbons, carbon fiber, organic high molecular compound baked bodies, and the like. The above electrically conductive materials can be used in only one kind. Alternatively, the above electrically conductive materials can be used in combination of two or more kinds by, for example, mixed use of artificial graphite and carbon black.

Examples of the binding agent include polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, thermoplastic resins such as thermoplastic polyimide, polyethylene, and polypropylene, acrylic resin, and styrene butadiene rubber. Note that the binding agent also functions as a thickener.

The cathode mix can be obtained by, for example, pressing the cathode active material, the electrically conductive material, and the binding agent on the cathode current collector, or causing the cathode active material, the electrically conductive material, and the binding agent to be in the form of paste by use of an appropriate organic solvent.

Examples of the cathode current collector include electrically conductive materials such as Al, Ni, and stainless steel, and Al, which is easy to process into a thin film and less expensive, is more preferable.

Examples of a method for producing the sheet cathode, i.e., a method for causing the cathode current collector to support the cathode mix include: a method in which the cathode active material, the electrically conductive material, and the binding agent which are to be formed into the cathode mix are pressure-molded on the cathode current collector; a method in which the cathode current collector is coated with the cathode mix which has been obtained by causing the cathode active material, the electrically conductive material, and the binding agent to be in the form of paste by use of an appropriate organic solvent, and a sheet cathode mix obtained by drying is pressed so as to be closely fixed to the cathode current collector; and the like. The paste preferably contains a conductive auxiliary agent and the binding agent.

Examples of the conductive auxiliary agent include carbon materials such as acetylene black, Ketjenblack, and graphite powder.

Normally, a sheet anode in which an anode current collector supports thereon an anode mix containing an anode active material is used as the anode. The sheet anode preferably contains the electrically conductive material and the binding agent.

Examples of the anode active material include a material that is capable of doping and dedoping lithium ions, lithium metal or lithium alloy, and the like. Specific examples of such a material include: carbonaceous materials such as natural graphite, artificial graphite, cokes, carbon black, pyrolytic carbons, carbon fiber, and organic high molecular compound baked bodies; chalcogen compounds such as oxides and sulfides each doping and dedoping lithium ions at a lower potential than that of the cathode; metals such as aluminum (Al), lead (Pb), tin (Sn), bismuth (Bi), and silicon (Si) each alloyed with an alkali metal; cubic intermetallic compounds (AlSb, Mg₂Si, NiSi₂) having lattice spaces in which alkali metals can be provided; lithium nitrogen compounds (Li₃₋ₓMₓN (M: transition metal)); and the like. Of the above anode active materials, a carbonaceous material which contains, as a main component, a graphite material such as natural graphite or artificial graphite is preferable. Further, an anode active material which is a mixture of graphite and silicon and has an Si to C ratio of not less than 5% is more preferable, and an anode active material which is a mixture of graphite and silicon and has an Si to C ratio of not less than 10% is still more preferable. This is because such a carbonaceous material is high in potential evenness, and a great energy density can be obtained in a case where the carbonaceous material, which is low in average discharge potential, is combined with the cathode.

The anode mix can be obtained by, for example, pressing the anode active material on the anode current collector, or causing the anode active material to be in the form of paste by use of an appropriate organic solvent.

Examples of the anode current collector include Cu, Ni, stainless steel, and the like, and Cu, which is difficult to alloy with lithium particularly in a lithium ion secondary battery and easy to process into a thin film, is more preferable.

Examples of a method for producing the sheet anode, i.e., a method for causing the anode current collector to support the anode mix include: a method in which the anode active material to be formed into the anode mix is pressure-molded on the anode current collector; a method in which the anode current collector is coated with the anode mix which has been obtained by causing the anode active material to be in the form of paste by use of an appropriate organic solvent, and a sheet anode mix obtained by drying is pressed so as to be closely fixed to the anode current collector; and the like. The paste preferably contains the conductive auxiliary agent and the binding agent.

The nonaqueous electrolyte secondary battery member can be formed by providing the cathode, the nonaqueous electrolyte secondary battery laminated separator, and the anode in this order. Thereafter, the nonaqueous electrolyte secondary battery member is placed in a container serving as a housing of the nonaqueous electrolyte secondary battery. Subsequently, the container is filled with a nonaqueous electrolyte, and then the container is sealed while being decompressed. The nonaqueous electrolyte secondary battery in accordance with an embodiment of the present invention can thus be produced. The nonaqueous electrolyte secondary battery, which is not particularly limited in shape, can have any shape such as a sheet (paper) shape, a disc shape, a cylindrical shape, or a prismatic shape such as a rectangular prismatic shape. Note that a method for producing the nonaqueous electrolyte secondary battery is not particularly limited to any specific method, and a conventionally publicly known production method can be employed as the method.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### EXAMPLES

[1. Method for Measuring Various Physical Properties]

Various physical properties of nonaqueous electrolyte secondary battery laminated separators in accordance with the following Examples and Comparative Examples were measured by the method below.

(1) Measurement of Shear Viscosity

Shear viscosities of respective coating solutions used in Examples 1 to 4 and Comparative Examples 1 to 3 were each measured continuously at each of respective shear rates of Intervals 1 and 2 under conditions as below. For this measurement, a rheometer (MCR301 manufactured by Anton-Paar GmbH) was used. Then, shear viscosities measured at a shear rate of 0.4 [1/sec] in Interval 2 were employed.
Jig used for measurement: cone plate (CP-50-1)
Measurement position: 1 mm
Measurement temperature: 25° C.
Shear rate in Interval 1: 0.1 [1/sec] to 1000 [1/sec]
Shear rate in Interval 2: 1000 [1/sec] to 0.1 [1/sec]

(2) Atomic Composition Percentage of Oxygen Contained in Inorganic Particles

The following shows a method of calculating an atomic composition percentage [at %] of oxygen contained in inorganic particles of Example 1.
Chemical Formula: BaTi_{0.8}Zr_{0.2}O₃
Ba:Ti:Zr:O=1:0.8:0.2:3
Atomic composition percentage [at %] of oxygen=3/(1+0.8 +0.2+3)×100=60 [at %]

In regard to inorganic particles used in each of Examples 2 to 4 and Comparative Examples 1 to 3, an atomic composition percentage of oxygen was similarly calculated.

(3) Measurement of Temperature Change Behavior of Separator in Case of Microwave Irradiation

A piece measuring 4 cm×4 cm was cut out from each of nonaqueous electrolyte secondary battery laminated separators prepared as described below in Examples 1 to 4 and Comparative Examples 1 to 3, respectively. Then, the piece was impregnated with a solution containing propylene carbonate, SN-WET 980 (manufactured by San Nopco Limited), and water in a weight ratio (propylene carbonate: SN-WET 980: water) of 85:12:3. Next, the piece of each of the above separators was spread out on a Teflon (registered trademark) sheet (size: 12 cm×10 cm) and then folded in half such that a surface of a porous layer sandwiches an optical fiber thermometer (Neoptix Reflex thermometer, manufactured by Astec Co., Ltd.) coated with Teflon (registered trademark) in the sheet thus folded. Thereafter, a PTFE plate for preventing floating of the separator was placed on the piece of each of the separators except for an area 1 mm from the thermometer so as to ensure a contact between the thermometer and the surface of the porous layer.

Next, the piece of each of the separators, which had been impregnated with the above solution and in which the thermometer was provided, was fixed in a microwave irradiation apparatus including a turntable (9 kW microwave oven manufactured by Micro Denshi Co., Ltd. and having a frequency of 2455 MHz), and the piece was irradiated with a microwave at 1800 W for two minutes.

Then, a change in temperature of the piece of each of the separators in case of microwave irradiation was measured every 0.2 seconds by use of the optical fiber thermometer.

A temperature increase rate (° C./sec) of the surface of the porous layer was defined as a slope at a maximum contribution rate which is obtained by a straight-line approximation of a relation between a temperature of the surface of the porous layer and a microwave irradiation time from the start of the microwave irradiation to 15 seconds after the start of the microwave irradiation.

(4) Measurement of Thermal Expansion Coefficient

A thermal expansion coefficient (ppm/° C.) in a temperature range of −40° C. to 200° C. of inorganic particles used in each of Examples 1 to 4 and Comparative Examples 1 to 3 was measured under the following condition by use of TMA402 F1 Hyperion (manufactured by NETZSCH):
Measuring atmosphere: helium
Measuring load: 0.02 N
Temperature increase rate: 5° C./min
Reference material: quartz
Measurement method: compression mode

(5) Rate Test

New nonaqueous electrolyte secondary batteries, each of which has not been subjected to any cycle of charge and discharge, were each subjected to four cycles of initial charge and discharge. Each of the four cycles of the initial charge and discharge was carried out at 25° C., at a voltage ranging from 4.1 V to 2.7 V, and at an electric current value of 0.2 C. Note that a value of an electric current at which a battery rated capacity defined as a one-hour rate discharge capacity is discharged in one hour is assumed to be 1 C. This applies also to the following descriptions.

Next, the nonaqueous electrolyte secondary batteries, which had been subjected to the initial charge and discharge, were each subjected to the following cycles (i) to (v) of charge and discharge at 55° C.: (i) three cycles of charge at a constant charge electric current value of 1.0 C and discharge at a constant discharge electric current value of 0.2 C; (ii) three cycles of charge at a constant charge electric current value of 1.0 C and discharge at a constant discharge electric current value of 1 C; (iii) three cycles of charge at a constant charge electric current value of 1.0 C and discharge at a constant discharge electric current value of 5 C; (iv) three cycles of charge at a constant charge electric current value of 1.0 C and discharge at a constant discharge electric current value of 10 C; and (v) three cycles of charge at a constant charge electric current value of 1.0 C and discharge at a constant discharge electric current value of 20 C. Then, an initial rate characteristic was calculated according to the following formula by using discharge capacities each obtained in the third cycle.

Initial rate characteristic (%) =(discharge capacity at 20 C/discharge capacity at 0.2 C)×100

[2. Preparation of Nonaqueous Electrolyte Secondary Battery Laminated Separators]

Nonaqueous electrolyte secondary battery laminated separators in accordance with Examples 1 to 4 and Comparative Examples 1 to 3 were prepared as below, respectively.

### Example 1

(Production of Coating Solution)

Barium titanate zirconate (BTZ-01-8020, manufactured by Sakai Chemical Industry Co., Ltd.) as inorganic particles, a vinylidene fluoride-hexafluoropropylene copolymer (“KYNAR2801” (product name), manufactured by Arkema Inc.) as a binder resin, and N-methyl-2-pyrrolidone (manufactured by Kanto Chemical Co., Inc.) as a solvent were mixed with one another as follows.

First, a mixture of the vinylidene fluoride-hexafluoropropylene copolymer and barium titanate zirconate was obtained by adding 10 parts by weight of the vinylidene fluoride-hexafluoropropylene copolymer to 90 parts by weight of barium titanate zirconate. Next, to the mixture thus obtained, the solvent was added so that a solid content concentration (a sum of a concentration of the barium titanate zirconate and a concentration of the vinylidene fluoride-hexafluoropropylene copolymer) became 40% by weight. A mixed liquid was thus obtained. This mixed liquid was stirred and mixed with use of a planetary centrifugal mixer (“AWATORI RENTARO” (product name), manufactured by Thinky Corporation) and a thin-film spin system high-speed mixer (FILMIX, manufactured by PRIMIX Corporation) so as to give a uniform coating solution 1.

(Formation of Porous Layer)

The coating solution 1 obtained as above was applied to one side of a porous film (thickness: 12 μm, porosity: 44%) made of polyethylene. A resultant coating film was dried at 80° C. with use of an air blowing dryer (model: WFO-601SD, manufactured by Tokyo Rikakikai Co., Ltd.), so that a separator 1 was produced. In the separator 1, the porous layer containing barium titanate zirconate was provided on one side of the porous layer was formed. In formation of the porous layer, a doctor blade clearance was adjusted so that a mass per unit area of the porous layer would be 7 g/m².

### Example 2

A separator 2 was obtained by an operation as in Example 1 except that lithium metasilicate (manufactured by Toyoshima Mfg. Co., Ltd., D50=3 μm) was used as inorganic particles.

### Example 3

A separator 3 was obtained by an operation as in Example 1 except that calcium titanate (manufactured by Toyoshima Mfg. Co., Ltd., D50=0.3 μm) was used as inorganic particles.

### Example 4

A separator 4 was obtained by an operation as in Example 1 except that aluminum titanate (manufactured by Toyoshima Mfg. Co., Ltd., D50=0.9 μm) was used as inorganic particles.

### Comparative Example 1

A separator 5 was obtained by an operation as in Example 1 except that borax (manufactured by Wako Pure Chemical Industries, Ltd.) classified with the use of a sieve having a mesh size of 53 μm was used as inorganic particles.

### Comparative Example 2

A separator 6 was obtained by an operation as in Example 1 except that alumina (AKP3000, manufactured by Sumitomo Chemical Co., Ltd.) was used as inorganic particles and that only the planetary centrifugal mixer (“AWATORI RENTARO” (product name), manufactured by Thinky Corporation) was used for stirring and mixing.

### Comparative Example 3

A separator 7 was obtained by an operation as in Example 1 except that magnesium oxide (500-04R, manufactured by Kyowa Chemical Industry Co., Ltd.) was used as inorganic particles and that a solid content concentration (a sum of a concentration of magnesium oxide and a concentration of a vinylidene fluoride-hexafluoropropylene copolymer) was set to 30% by weight.

[3. Production of Nonaqueous Electrolyte Secondary Battery]

Next, nonaqueous secondary batteries were produced as below by using the nonaqueous secondary battery laminated separators of Examples 1 through 4 and Comparative Examples 1 through 3, which were prepared as above.

<Cathode>

A commercially available cathode which was produced by applying LiNi_{0.5}Mn_{0.3}Co_{0.2}O₂/conductive material/PVDF (weight ratio 92/5/3) to an aluminum foil was used. The aluminum foil of the cathode was cut so that a portion of the cathode where a cathode active material layer was formed had a size of 45 mm×30 mm and a portion where the cathode active material layer was not formed, with a width of 13 mm, remained around that portion. The cathode active material layer had a thickness of 58 μm and a density of 2.50 g/cm³. The cathode had a capacity of 174 mAh/g.

<Anode>

A commercially available anode produced by applying graphite/styrene-1,3-butadiene copolymer/carboxymethyl cellulose sodium (weight ratio 98/1/1) to a copper foil was used. The copper foil of the anode was cut so that a portion of the anode where an anode active material layer was formed had a size of 50 mm×35 mm, and a portion where the anode active material layer was not formed, with a width of 13 mm, remained around that portion. The anode active material layer had a thickness of 49 μm and a density of 1.40 g/cm³. The anode had a capacity of 372 mAh/g.

<Assembly>

In a laminate pouch, the cathode, the nonaqueous secondary battery laminated separator in which the porous layer was arranged to face the cathode, and the anode were laminated (provided) in this order so that a nonaqueous electrolyte secondary battery member would be obtained. In this case, the cathode and the anode were positioned such that a whole of a main surface of the cathode active material layer of the cathode was included in an extent of a main surface (overlapped the main surface) of the anode active material layer of the anode.

Subsequently, the nonaqueous electrolyte secondary battery member was put in a bag made by laminating an aluminum layer and a heat seal layer, and 0.25 mL of a nonaqueous electrolyte was poured into the bag. The nonaqueous electrolyte was an electrolyte at 25° C. obtained by dissolving LiPF₆ with a concentration of 1.0 mole per liter in a mixed solvent of ethyl methyl carbonate, diethyl carbonate, and ethylene carbonate in a volume ratio of 50:20:30. The bag was heat-sealed while a pressure inside the bag was reduced, so that a nonaqueous secondary battery was produced. The nonaqueous electrolyte secondary battery had a design capacity of 20.5 mAh.

[4. Results of Measurement of Various Physical Properties]

Table 1 shows the results of measurement of various physical properties for each of the nonaqueous electrolyte secondary battery laminated separators of Examples 1 through 4 and Comparative Examples 1 through 3.

TABLE 1

| | | Atomic | Temper- | | |
|---|---|---|---|---|---|
| | | Composition | ature | Thermal | Initial |
| | Shear | Percentage | Increase | Expansion | Rate |
| | Viscosity | of Oxygen | Rate | Coefficient | Charac- |
| | [Pa · s] | [at %] | [° C./sec] | [ppm/° C.] | teristic |
| Example 1 | 0.309 | 60 | 1.23 | 7.3 | 70 |
| Example 2 | 0.213 | 60 | 1.17 | 10.5 | 71.6 |
| Example 3 | 0.965 | 63 | 0.97 | 1.6 | 71.3 |
| Example 4 | 0.201 | 64 | 0.95 | 5.2 | 70.8 |
| Comparative | 1.373 | 33 | 0.9 | 12.2 | 34.2 |
| Example 1 | | | | | |
| Comparative | 1.107 | 60 | 1.28 | 5.5 | 55.3 |
| Example 2 | | | | | |
| Comparative | 9.157 | 50 | 1.06 | 11.1 | 54.1 |
| Example 3 | | | | | |

As shown in Table 1, the nonaqueous electrolyte secondary battery laminated separators of Examples 1 to 4 had a thermal expansion coefficient of not more than 11 ppm/° C. and a porous layer surface temperature increase rate of not more than 1.25° C./sec. These nonaqueous electrolyte secondary battery laminated separators were each superior in initial rate characteristic to the nonaqueous electrolyte secondary battery laminated separators of Comparative Examples 1 and 3 each of which has a thermal expansion coefficient of more than 11 ppm/° C., and to the nonaqueous electrolyte secondary battery laminated separator of Comparative Example 2 having a porous layer surface temperature increase rate of more than 1.25° C./sec.

In addition, in a case where the shear viscosity is suppressed to a low value and the atomic composition percentage of oxygen is not less than 60 at % as in Examples 1 to 4, control of the temperature increase rate in a preferred range is considered to be possible.

### INDUSTRIAL APPLICABILITY

An embodiment of the present invention is applicable to production of nonaqueous electrolyte secondary batteries each of which has an excellent initial rate characteristic.

1. A nonaqueous electrolyte secondary battery laminated separator comprising:
a porous film containing a polyolefin-based resin; and
a porous layer containing inorganic particles,
the inorganic particles having a thermal expansion coefficient of not more than 11 ppm/° C. in a temperature range of −40° C. to 200° C., and
the porous layer having a surface temperature increase rate of not more than 1.25° C./sec in a period from a start of microwave irradiation to 15 seconds after the start of microwave irradiation, in a case where the nonaqueous electrolyte secondary battery laminated separator is impregnated with a solution containing propylene carbonate, a polyoxyalkylene-type non-ionic surfactant and water in a weight ratio of 85:12:3 and is subsequently irradiated, at an output of 1,800 W, with a microwave having a frequency of 2,455 MHz, the weight ratio being a ratio of the propylene carbonate: the polyoxyalkylene-type non-ionic surfactant: water.

2. The nonaqueous electrolyte secondary battery laminated separator as set forth in claim 1, wherein the inorganic particles contain an oxygen element.

3. The nonaqueous electrolyte secondary battery laminated separator as set forth in claim 2, wherein an oxygen atomic composition percentage of the inorganic particles containing the oxygen element is not less than 60 at %.

4. A nonaqueous electrolyte secondary battery member comprising:
a cathode;
a nonaqueous electrolyte secondary battery laminated separator as set forth in claim 1; and
an anode,
the cathode, the nonaqueous electrolyte secondary battery laminated separator, and the anode being provided in this order.

5. A nonaqueous electrolyte secondary battery comprising a nonaqueous electrolyte secondary battery laminated separator as set forth in claim 1.
